(19) United States
(12) Patent Application Publication
(10) Pub. No.: US 2024/0360962 A1
(43) Pub. Date: Oct. 31, 2024

(54) Pressure Vessel Assembly and Motor Vehicle

(71) Applicant: Bayerische Motoren Werke Aktiengesellschaft, Muenchen (DE)

(72) Inventors: Timo GUTMANN, Bad Kohlgrub (DE); Eric HENDEL, Frickenhausen (DE); Christoph WARKOTSCH, Muenchen (DE)

(21) Appl. No.: 18/292,159

(22) PCT Filed: Jul. 20, 2022
(86) PCT No.: PCT/EP2022/070397

§ 371 Date: Jan. 25, 2024

(30) Foreign Application Priority Data
Jul. 26, 2021 (DE) 10 2021 119 226.9

(51) Int. Cl. F17C 13/08; F16C 27/06

(52) U.S. Cl. CPC F17C 13/084; F16C 27/063; F17C 2201/0109; F17C 2205/0111; F17C 2205/013; F17C 2221/012; F17C 2221/033; F17C 2270/0168

(57) ABSTRACT

A pressure vessel assembly having a plurality of pressure vessels, a plurality of fixed bearings and a plurality of floating bearings is disclosed. Longitudinal axes of the pressure vessels are oriented parallel to each other. A motor vehicle includes such a pressure vessel assembly.

### BACKGROUND AND SUMMARY

The technology disclosed herein concerns a pressure vessel assembly and a motor vehicle having such a pressure vessel assembly.

Pressure vessels are used for example to store gaseous fuel. They can be used for example to supply gas-powered combustion engines or fuel cells. In particular, they can be used in motor vehicles or other mobile units, but also in stationary units.

A preferred object of the technology disclosed herein is to reduce or eliminate at least one drawback of a previously known solution or to propose an alternative solution. In particular, a preferred object of the technology disclosed herein is to provide improved mounting of pressure vessels. Further preferred objects may become apparent from the advantageous effects of the technology disclosed herein. The objects are achieved by the subject matter of the independent claims. The dependent claims present preferred refinements.

The technology disclosed herein concerns a pressure vessel assembly having (i) a plurality of pressure vessels, (ii) a plurality of fixed bearings, wherein first longitudinal ends of the pressure vessels are held by the fixed bearings, and (iii) a plurality of floating bearings, wherein second longitudinal ends of the pressure vessels, which are arranged at the opposite end from the first longitudinal ends, are held by the floating bearings, wherein longitudinal axes of the pressure vessels are oriented parallel to one another.

As a result of pressure vessels being mounted in such a way in a pressure vessel assembly, it is possible for there to be a defined installed condition of the pressure vessels at the fixed bearings, it being possible for this installed condition to be used for example for a continuous connection line. Length differences that arise during operation of the pressure vessels, for example on account of pressure changes or temperature changes, can advantageously be compensated at the floating bearings without this causing excessive stress.

A fixed bearing may be understood to be in particular a bearing which, compared to a reference, for example a vehicle body, establishes a defined installed condition of the held object, in this case in particular a pressure vessel. By contrast, a floating bearing is understood to be a bearing which allows at least one degree of freedom within certain limits, such that, for example, compensation of length changes or other dimensional changes is possible without this causing tension. Longitudinal axes of the pressure vessels may for example be entirely or at least substantially axes of symmetry of the pressure vessels. As a result of the parallel arrangement, in particular a compact and space-saving embodiment can be realized.

According to one embodiment, the floating bearings are each embodied by means of an inner sleeve and an outer sleeve, wherein a flexible and/or elastic material is arranged between the inner sleeve and the outer sleeve. The inner sleeves are, in particular, fastened to a second longitudinal end of the pressure vessel. In particular, each inner sleeve is fastened to a second longitudinal end of in each case one pressure vessel. The flexible and/or elastic material may in particular absorb possible length changes or other dimensional changes. A flexible material may in this case be understood to be in particular a material which is bendable at least within certain limits. An elastic material may be understood to be in particular a material which meets such bending with a certain opposing force.

The outer sleeve may, in particular, be fastened in a floating bearing mount. The floating bearing mount may extend in particular over several or all floating bearings and hold these jointly. This allows a simple and compact structure.

The inner sleeve may, in particular, be screwed together with the second longitudinal end of the pressure vessel. This allows a stable connection and easy connection and detachment via a screwing movement. The inner sleeve may, in particular, be longer than the outer sleeve as seen along a longitudinal direction of the pressure vessel. As a result, advantageous movability is achieved, in particular when the abovementioned elastic material is located between the two sleeves. The flexible and/or elastic material may, in particular, be rubber. For example, materials such as butadiene rubber (BR), acrylonitrile butadiene rubber (NBR) or ethylene propylene diene rubber (EPDM) may be used.

The inner sleeve and the outer sleeve may, in particular, be vulcanized onto the flexible and/or elastic material. It is also possible for only one of these two sleeves to be vulcanized on. As a result, a reliable and durable connection is achieved. Other types of connection can also be used, however.

According to one embodiment, the floating bearings are each formed by a pin attached to the second end of the pressure vessel and by a sleeve, wherein the sleeve holds the pin. The sleeve may, in particular, be in the form of a metallic receptacle. The pin may, in particular, be a cylindrical pin and may, in particular, be part of a boss of the pressure vessel. The receptacle may, in particular, be part of a floating bearing mount, or it may be fastened in such a floating bearing mount.

According to one embodiment, the fixed bearings are each realized by means of a spherical-segment-shaped region at the first longitudinal end of the pressure vessel and by a mounting element complementary thereto, wherein the mounting element holds the spherical-segment-shaped region. By means of such a spherical-segment-shaped region, it is possible, in particular, for at least limited pivotability of the pressure vessel in the fixed bearing to be realized, such that it is possible advantageously to react to cardanic stresses.

According to one embodiment, the fixed bearings may each be realized by means of a rubber ring which surrounds the first longitudinal end of the pressure vessel. The rubber ring may, in particular, be designed to be hard enough to realize the fixed bearing function. The rubber ring may, in particular, be held in a form-fitting manner by an outer ring which is arranged directly radially outside the rubber ring. The outer ring may, in particular, be split in particular by fracturing prior to assembly. Subsequently, it is possible, in particular, for the two halves of the outer ring to be placed in a form-fitting manner around the rubber ring. They can then be reconnected.

According to one embodiment, the rubber ring is held axially on the inner ring by a groove. The outer ring may, in particular, project into a groove in the rubber ring by means of a preferably rotationally symmetric bead. Other form-fitting embodiments are also possible here, however; for example, such a bead may also be formed on the inner ring and/or a groove may be formed on the outer ring. Typically, the inner ring and outer ring are fastened such that the rubber ring exhibits an axial form fit both with the inner ring and with the outer ring such that axial forces can be transmitted.

It is possible, in particular, for a plurality of frontal pocket-like and/or kidney-shaped recesses to be formed in the rubber ring. These can be formed on one side or on both sides, i.e. in particular on the container side and/or on the opposite side from the container. They serve in particular for better resilience under cardanic stress.

The inner ring may, in particular, have an internal thread into which the first longitudinal end of the pressure vessel is screwed. The inner ring may, in particular, be metallic. As a result of screwing, reliable fastening that is easy to produce and release is achieved. In particular, it is also possible for fixing bores to be provided in the inner ring or in the rubber ring, and these may serve, in particular, for holding in place during screwing.

The pressure vessel assembly may, according to one embodiment, have at least one media line which is fluidically connected to the pressure vessels at the first longitudinal ends. As a result, the fixed bearing functionality can be used to ensure a defined positional relationship of the first longitudinal ends and thus to prevent any bending of the media line.

The technology disclosed herein also concerns a motor vehicle having a pressure vessel assembly as described herein. With regard to the pressure vessel assembly, reference may be made to all the embodiments and variants described herein. The motor vehicle may, in particular, also have a gas-powered combustion engine or a fuel cell, which is supplied with gaseous fuel from the pressure vessels.

A pressure vessel assembly may, in particular, be understood to be a structural unit. This denotes, in particular, the pressure vessels together with permanently attached structural support elements, fastening elements and protective features, for example screens, barriers, windings and coatings, which can be removed and re-installed, for example for maintenance and inspection purposes, only using specialist tools and/or operations.

The pressure vessel assembly may be used, in particular, for a motor vehicle (for example passenger cars, motorcycles, commercial vehicles). The pressure vessel assembly serves, in particular, for storing fuel that is gaseous under environmental conditions. The pressure vessel assembly may be used for example in a motor vehicle which is powered by compressed natural gas (or CNG) or liquid natural gas (or LNG) or by hydrogen. The pressure vessel assembly is typically fluidically connected to at least one energy converter, which is designed to convert the chemical energy of the fuel into other forms of energy.

Such a pressure vessel assembly typically comprises a plurality of pressure vessels, in particular composite overwrapped pressure vessels. A pressure vessel may be, for example, a cryogenic pressure vessel or a high pressure gas tank. High pressure gas tanks are designed to durably store fuel at ambient temperatures and at a nominal working pressure (or NWP) of at least 350 barg (=positive pressure compared with atmospheric pressure) or at least 700 barg. A cryogenic pressure vessel is suitable for storing the fuel at the abovementioned operating pressures and also at temperatures that are much (for example more than 50 K or more than 100 K) lower than the operating pressure of the motor vehicle.

The pressure vessel assembly may, in particular, form a unit which may be able to be fitted in an underfloor area beneath the passenger compartment of a motor vehicle. The longitudinal axes of the pressure vessels may, in the installed condition, extend in particular parallel to one another and/or individual pressure vessels may each have a length-to-diameter ratio with a value of between 4 and 200, preferably between 5 and 100, and particularly preferably between 6 and 50.

The pressure vessel assembly may preferably be able to be fitted as a whole in the installation space provided in the motor vehicle. To this end, the pressure vessel assembly may have common vehicle-body attachment points, by means of which the assembly as a whole is able to be fastened in the motor vehicle. Preferably, the pressure vessel assembly comprises more than three or more than five or more than seven or more than ten pressure vessels.

In other words, current efforts in the development of fuel cell vehicles indicate using an installation space beneath a vehicle tank for the integration of hydrogen pressure vessels. If there is a pressure change in a pressure vessel, axial expansion of the vessel length occurs. In order to simplify the connection of high-pressure extraction lines, it is advantageous to prevent this expansion as far as possible on the extraction side. This may take place, for example, by way of a fixed bearing function. Advantageously, a fastening can then fully compensate, on the opposite side, for the change in length that arises as a result of the expansion. This may take place, for example, by way of a floating bearing function.

A fixed bearing function may be realized for example through the use of sleeve joints (ball joints) which are screwed as a neck mounting to the bosses of the vessels. The media extraction is guided through the inner bore in the sleeve bearing. The joint function makes it possible to compensate for manufacture-related angle tolerances without problems. The sleeve joints may have been pressed into a common receptacle which has been fastened to the vehicle body.

A fixed bearing function may, in particular, be realized by the installation of a rubber bearing, enclosed in a form-fitting manner by metal rings, for each vessel as a neck mounting. The fitting of the rubber bearing may take place by insertion of the slotted rubber ring into the groove. The rubber ring may have kidney-shaped pockets which give the rubber bearings lower stiffness under angular stress and thus make it easier to compensate for angular tolerances. Following insertion of the rubber ring, the rubber bearing can be completed by attachment of the metallic outer ring split by fracturing. The completed rubber bearings can, in particular, be pressed into a common receptacle which is fastened to the vehicle body. Subsequently, the bosses of the vessels can be screwed in, while the inner rings of the rubber bearings are held in place at the fixing bores.

A floating bearing function may be realized, for example, through the use of a rubber bearing having two metal sleeves vulcanized on for each container as a neck mounting. The inner metal sleeve may be screwed together with the boss of the container, wherein the screwing can also be embodied such that it is possible for media to pass through the inner sleeve. The outer sleeves of the rubber bearing may be pressed into a common receptacle which is fastened to the vehicle body. The compensation of the axial vessel expansion can take place in that the inner sleeve of the rubber bearing moves outward and in the process elastically deforms the rubber body. The inner sleeve may be longer than the outer sleeve, for example in order to make a deformation path available.

A floating bearing function may be realized for example by the use of a floating bearing for each vessel. In this case, the necessary tribological properties can be realized by pairing a metallic receptacle with a pin as boss, which carries a plastics sleeve. Equally, the plastics sleeves may be part of the common receptacle, into which a metallic counterpart of the boss is plugged. The common receptacle may be screwed to the vehicle body.

The technology disclosed herein will now be described with reference to the figures.

### BRIEF DESCRIPTION OF THE DRAWINGS

FIG. 1 shows a pressure vessel assembly;

FIG. 2 shows an embodiment of a fixed bearing;

FIG. 3 shows a further embodiment of a fixed bearing;

FIG. 4 shows a part of the fixed bearing in FIG. 3;

FIG. 5 shows another view of the embodiment of a fixed bearing in FIG. 3;

FIG. 6 shows a pressure vessel assembly;

FIG. 7 shows an embodiment of a floating bearing;

FIG. 8 shows a pressure vessel assembly; and

FIG. 9 shows an embodiment of a floating bearing.

### DETAILED DESCRIPTION OF THE DRAWINGS

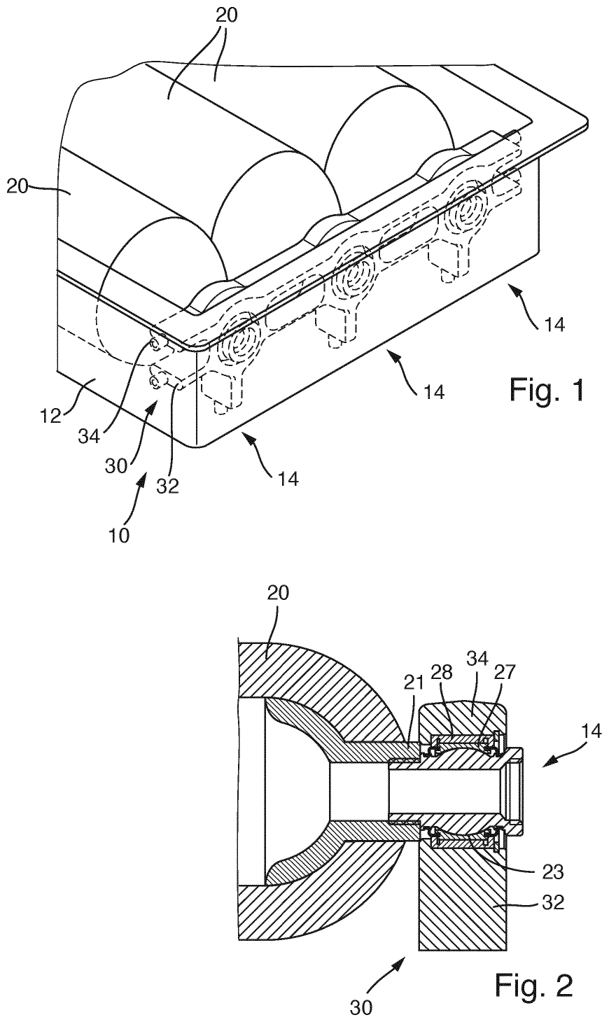

FIG. 1 shows a pressure vessel assembly 10 purely schematically. The pressure vessel assembly 10 has a housing 12 in which, in the present case, a total of three pressure vessels 20 are located. These are designed such that their longitudinal axes are parallel to one another.

For fastening the pressure vessels 20, use is made, in the illustrated detail of the pressure vessel assembly 10, of three fixed bearings 14, which are not illustrated in more detail in FIG. 1. This is reserved for the following figures. The fixed bearings 14 are arranged in a fixed bearing holder 30 which is divided into a lower holder part 32 and an upper holder part 34.

One possible embodiment of a fixed bearing 14 is shown in FIG. 2. In this case, it is apparent that a first longitudinal end 21 of a pressure vessel 20 extends into the fixed bearing holder 30. Formed at the first longitudinal end 21 of the pressure vessel 20 is a spherical-segment-shaped region 23, i.e. this portion externally has the shape of a spherical segment. In a complementary manner thereto, a holding element 28 and a mounting element 27 having a surface complementary to the spherical-segment-shaped region 23, i.e. a negatively spherical-segment-shaped surface, are formed within the fixed bearing holder 30.

With such an embodiment, the pressure vessel 20 is mounted without play with regard to any longitudinal movement. This allows a defined positional relationship, in particular relative to a surrounding vehicle body or to the housing 12. A cardanic movement is possible, however, such that any manufacturing tolerances or temperature-related expansions or expansions caused by a different filling level of the pressure vessel 20 can be compensated easily without stresses occurring.

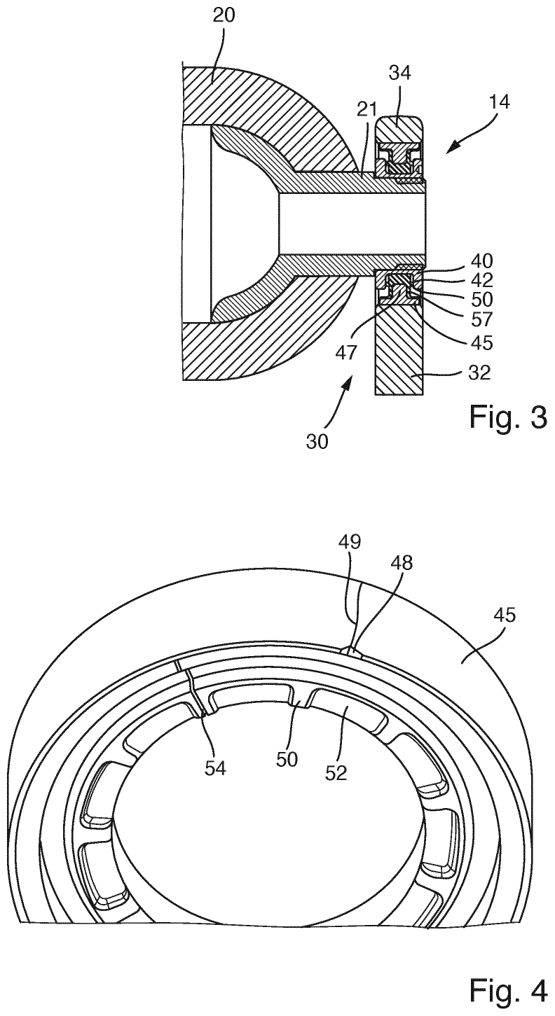

FIG. 3 shows an alternative realization of a fixed bearing 14. In this case, an inner ring 40 is provided, which, in the present case, has been screwed together with the first longitudinal end 21 of the pressure vessel 20 and has a groove 42. Furthermore, an outer ring 45 is provided, which has a rotationally symmetric bead 47. Between the inner ring 40 and the outer ring 45 there is a rubber ring 50 made of a hard rubber material, which engages in the groove 42 in the inner ring 40. For its part, it has a groove 57 in which the bead 47 engages. Thus, the rubber ring 50 is fastened axially in a form-fitting manner to the outer ring 45, and the inner ring 40 is fastened axially in a form-fitting manner to the rubber ring 50. This allows axial play-free mounting in a similar way to the embodiment in FIG. 2.

FIG. 4 shows the outer ring 45 and the rubber ring 50 in greater detail. It is apparent here that the outer ring 45 has an indentation 48 and a seam 49. By means of the indentation 48, fracturing was possible before the state shown here was established. As a result, it was possible for the outer ring 45 to be split into two parts. Once it surrounds the rubber ring 50, it is joined together again at the seam 49. This results in the state illustrated in FIG. 4.

As is also apparent, the rubber ring 50 has a plurality of frontal kidney-shaped recesses 52. These serve to ensure a certain cardanic movability in a similar way to the embodiment in FIG. 2. Furthermore, the rubber ring 50 also has slots 54, which likewise ensure a certain cardanic movability. Otherwise, the slots 54 also serve to make it easier to place the rubber ring 50 around the undivided inner ring 40 during assembly.

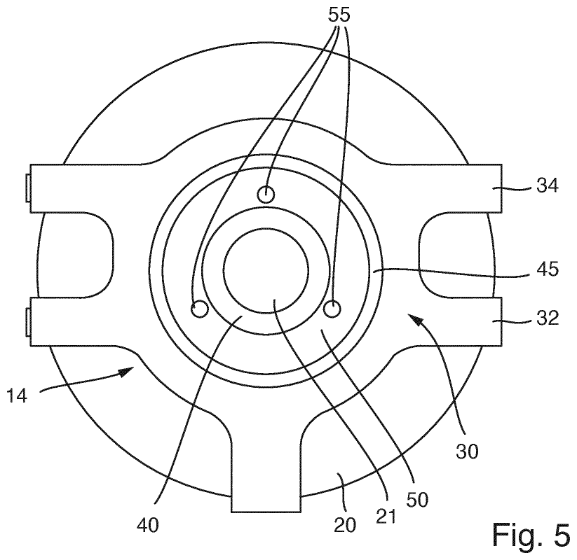

FIG. 5 shows the embodiment of a fixed bearing 14 according to FIGS. 3 and 4 in a side view. It is apparent here that the rubber ring 50 has, in the present case, three fixing bores 55 which can be held by means of a suitable tool in order to rotate the rubber ring 50 in a targeted manner or to stabilize it with respect to a rotary movement. This makes it possible to screw in a pressure vessel 20 or to screw the rubber ring 50 onto a pressure vessel 20.

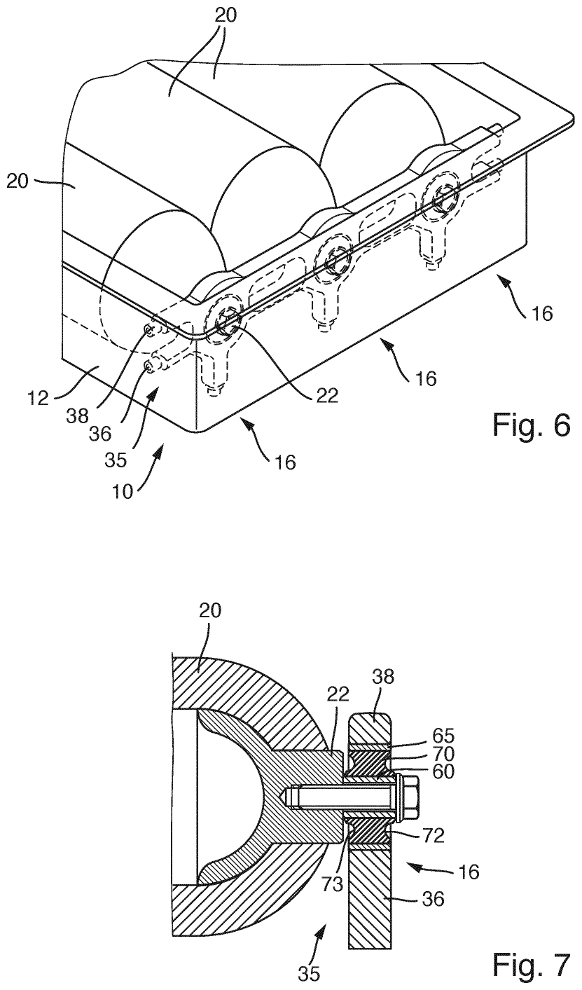

FIG. 6 shows a pressure vessel assembly 10 at second longitudinal ends 22 of the pressure vessel 20, which, unlike the view in FIG. 1, are not fastened by means of fixed bearings 14 but by means of floating bearings 16. In this case, a floating bearing holder 35 having a lower holder part 36 and an upper holder part 38 is provided. These may be embodied in principle in the same way as the fixed bearing holder 30 already described above.

The structure of a floating bearing 16 is illustrated in more detail in FIG. 7. In the present case, an inner sleeve 60 is provided, which has been screwed together with the second longitudinal end 22 of the respective pressure vessel 20, and an outer sleeve 65. Located in between is a flexible and elastic material 70.

In particular, it is also apparent here that the inner sleeve 60 has a greater longitudinal extent than the outer sleeve 65, and that the flexible and elastic material 70 has an external indentation 72 and an internal indentation 73. This ensures advantageous axial movability of the inner sleeve 60 relative to the outer sleeve 65, which is fixedly connected to the floating bearing holder 35. Any length changes, for example on account of temperature changes or changes in the filling of the pressure vessel 20, can be easily compensated in this way without any stresses arising in components that are not designed therefor.

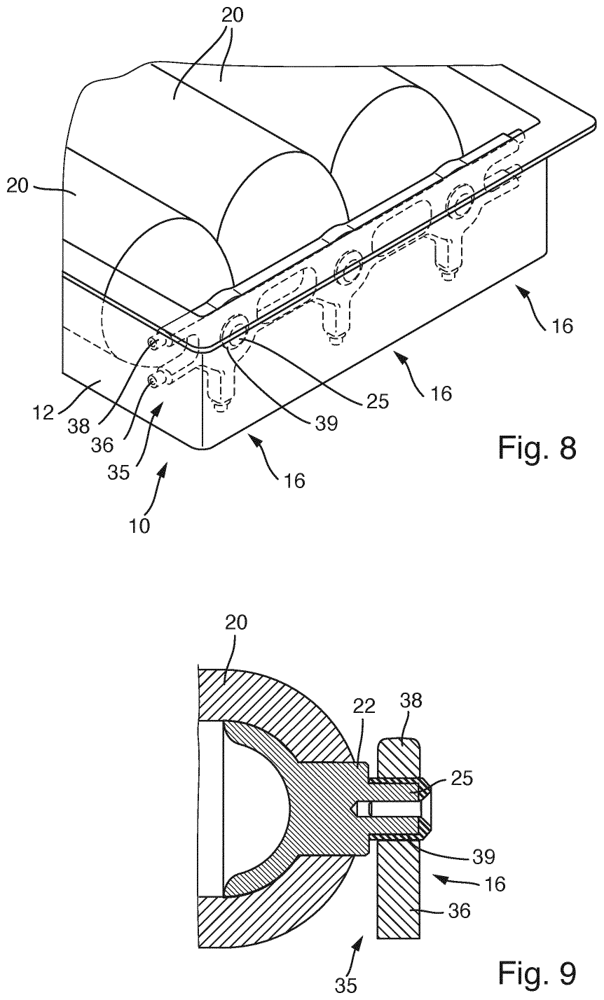

FIG. 8 shows a pressure vessel assembly 10 having an alternative embodiment of a floating bearing 16. This embodiment is also illustrated in FIG. 9. In this case, a pin 25 of the second longitudinal end 22 of the pressure vessel 20 projects into the floating bearing holder 35 and is held there by a sleeve 39. The sleeve 39 is received in an axially movable manner in the pin 25. This too has the advantageous result of floating mounting.

For legibility reasons, the expression “at least one” has sometimes been omitted for simplification purposes. When a feature of the technology described herein is described in the singular or using the indefinite article (for example the/a pressure vessel, the/a bearing etc.), the plural thereof is also intended to be disclosed at the same time (for example the at least one pressure vessel, the at least one bearing, etc.).

The preceding description of the present invention serves merely for illustrative purposes and not for the purpose of limiting the invention. In the scope of the invention, various amendments and modifications are possible without departing from the scope of the invention and the equivalents thereof.

List of reference signs

| | |
|---|---|
| 10 | Pressure vessel assembly |
| 12 | Housing |
| 14 | Fixed bearing |
| 16 | Floating bearing |
| 20 | Pressure vessel |
| 21 | First longitudinal end |
| 22 | Second longitudinal end |
| 23 | Spherical-segment-shaped region |
| 25 | Pin |
| 30 | Fixed bearing holder |
| 32 | Lower holder part |
| 34 | Upper holder part |
| 35 | Floating bearing holder |
| 36 | Lower holder part |
| 38 | Upper holder part |
| 39 | Sleeve |
| 40 | Inner ring |
| 42 | Groove |
| 45 | Outer ring |
| 47 | Bead |
| 48 | Indentation |
| 49 | Seam |
| 50 | Rubber ring |
| 52 | Recess |
| 54 | Slot |
| 55 | Fixing bores |
| 57 | Groove |
| 60 | Inner sleeve |
| 65 | Outer sleeve |
| 70 | Flexible and elastic material |
| 72 | External indentation |
| 73 | Internal indentation |

1.-15. (canceled)

16. A pressure vessel assembly, comprising:
a plurality of pressure vessels;
a plurality of fixed bearings, wherein first longitudinal ends of the pressure vessels are held by the fixed bearings; and
a plurality of floating bearings, wherein second longitudinal ends of the pressure vessels, which are arranged at an opposite end from the first longitudinal ends, are held by the floating bearings,
wherein longitudinal axes of the pressure vessels are oriented parallel to one another.

17. The pressure vessel assembly as claimed in claim 16, wherein the floating bearings each comprise:
an inner sleeve; and
an outer sleeve; and
a flexible and/or elastic material arranged between the inner sleeve and the outer sleeve,
wherein the inner sleeve is fastened to a second longitudinal end of the pressure vessel.

18. The pressure vessel assembly as claimed in claim 17, wherein the outer sleeve is fastened in a floating bearing mount.

19. The pressure vessel assembly as claimed in claim 17, wherein
the inner sleeve is screwed together with the second longitudinal end of the pressure vessel.

20. The pressure vessel assembly as claimed in claim 17, wherein
the inner sleeve is longer than the outer sleeve viewed along a longitudinal direction of the pressure vessel.

21. The pressure vessel assembly as claimed in claim 17, wherein the flexible and/or elastic material is rubber.

22. The pressure vessel assembly as claimed in claim 17, wherein
the inner sleeve and the outer sleeve are vulcanized onto the flexible and/or elastic material.

23. The pressure vessel assembly as claimed in claim 16, wherein
the floating bearings are each formed by a pin attached to the second longitudinal end of the pressure vessel, and by a sleeve, wherein the sleeve holds the pin.

24. The pressure vessel assembly as claimed in claim 17, wherein the fixed bearings each comprise:
a spherical-segment-shaped region at the first longitudinal end of the pressure vessel and a mounting element complementary thereto,
wherein the mounting element holds the spherical-segment-shaped region.

25. The pressure vessel assembly as claimed in claim 17, wherein
the fixed bearings each comprise a rubber ring which surrounds the first longitudinal end of the pressure vessel.

26. The pressure vessel assembly as claimed in claim 25, wherein
the rubber ring is held in a form-fitting manner by an outer ring which is arranged directly radially outside the rubber ring.

27. The pressure vessel assembly as claimed in claim 25, wherein
a plurality of frontal pocket-shaped and/or kidney-shaped recesses are formed in the rubber ring.

28. The pressure vessel assembly as claimed in claim 25, wherein
the inner ring has an internal thread into which the first longitudinal end of the pressure vessel is screwed.

29. The pressure vessel assembly as claimed in claim 16, further comprising:
at least one media line which is fluidically connected to the pressure vessels at the first longitudinal ends.

30. A motor vehicle comprising a pressure vessel assembly as claimed in claim 16.
